(19) United States
(12) Patent Application Publication
(10) Pub. No.: US 2009/0027431 A1
(43) Pub. Date: Jan. 29, 2009

(54) INKJET APPARATUS AND DRIVING METHOD, AND MANUFACTURING METHOD OF DISPLAY APPARATUS USING THE SAME

(76) Inventors: Kwang-Ho Lee, Gyeonggi-do (KR); Byoung-Joo Kim, Gyeonggi-do (KR); Jang-Sub Kim, Gyeonggi-do (KR); Yoon-Ho Kang, Gyeonggi-do (KR); Tae-Gee Min, Seoul (KR); Seong-Gyu Kwon, Gyeonggi-do (KR); Yi-Seop Shim, Gyeonggi-do (KR); Chang-Hun Kwak, Gyeonggi-do (KR); Jae-Jun Yu, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 12/177,723

(22) Filed: Jul. 22, 2008

(30) Foreign Application Priority Data
Jul. 26, 2007 (KR) 2007-75311

(51) Int. Cl. B41J 29/38

(52) U.S. Cl. 347/10; 29/592.1

(57) ABSTRACT

In one embodiment, a driving method of an inkjet apparatus, includes applying the same driving pulse to a plurality of piezoelectric elements; measuring a discharge speed and a discharge volume of a discharged object which is discharged through a plurality of nozzles; adjusting the discharge speed which comprises comparing the discharge speed and discharge volume of each nozzle with a predetermined reference permissible range to detect nozzle deviations from the reference permissible range, and adjusting the discharge characteristic of the one or more detected nozzles within the reference discharge permissible range.

### CROSS-REFERENCE TO RELATED APPLICATION

This application claims priority under 35 U.S.C. §119 to Korean Patent Application No. 10-2007-0075311, filed on Jul. 26, 2007 in the Korean Intellectual Property Office, the disclosure of which is incorporated herein by reference in its entirety.

### BACKGROUND OF THE INVENTION

1. Field of the Invention

The disclosure relates to a piezoelectric type inkjet apparatus and driving method, and a manufacturing method of a display apparatus using the same.

2. Description of the Related Art

A flat panel display apparatus includes a liquid crystal display (LCD) apparatus and an organic light emitting diode (OLED) display apparatus, etc. The flat panel display apparatus is formed with a color filter for endowing a light transmitting a substrate with a color, and/or an organic light emitting layer in which a hole and an electron are combined to make an exciton to emit a light if a voltage is applied thereto.

Hereinafter, a method of forming the color filter or the organic light emitting layer on a substrate by using a piezoelectric inkjet apparatus will be described.

The piezoelectric inkjet apparatus uses a piezoelectric element to discharge an ink through a plurality of nozzles attached to a print head. The piezoelectric element discharges the ink according to an inputted electric signal. Differences in the discharge channel size of the nozzles may occur during manufacture of the nozzles. In this regard, although the same electric signal may be input to the nozzles, the discharge volume and discharge speed of the nozzles may vary due to the difference of the discharge channel size in the nozzles. Accordingly, a chrominance stain is caused in the flat panel display apparatus due to the non-uniformity of the discharge volume and the discharge speed.

Also, the electric signal inputted to the piezoelectric inkjet apparatus is mainly transmitted in a driving pulse to discharge a predetermined discharge volume to a predetermined position of the substrate. To improve the discharging performance of the inkjet apparatus various complicated types of driving pulses, such as a double pulse, a triple pulse, a uni-polar pulse, a bi-polar pulse, etc have been developed and utilized. However, as the driving pulse may be varied and complicated, fluid vibration is overlapped in a high speed printing, thereby deteriorating the printing quality, and increasing the manufacturing cost of the apparatus.

### SUMMARY OF THE INVENTION

Accordingly, one embodiment provides for an inkjet apparatus individually controlling a plurality of nozzles to simply and easily control a discharge volume and a discharge speed of each nozzle, and to reduce the manufacturing cost of a driving controller.

Another aspect is to provide a driving method of an inkjet apparatus individually controlling a plurality of nozzles to simply and easily control a discharge volume and a discharge speed of each nozzle, and to reduce the manufacturing cost of a driving controller.

Still another aspect is to provide a manufacturing method of a display apparatus using an inkjet apparatus individually controlling a plurality of nozzles to simply and easily control a discharge volume and a discharge speed of each nozzle, and to reduce the manufacturing cost of a driving controller.

Additional aspects will be set forth in part in the description which follows and, in part, will be obvious from the description, or may be learned by practice of the subject matter described herein.

The foregoing and/or other aspects of the subject matter described herein can be achieved by providing a driving method of an inkjet apparatus, comprising: applying the same driving pulse to a plurality of piezoelectric elements; measuring a discharge speed and a discharge volume of a discharged object which is discharged by the applied driving pulse through a plurality of nozzles which respectively comprise the piezoelectric elements; adjusting the discharge speed which comprises comparing the discharge speed of each nozzle with a predetermined reference discharge speed permissible range to detect a nozzle which has a discharge speed which deviates from the reference discharge speed permissible range, and adjusting the magnitude of an applying voltage of the driving pulse which is applied to the detected nozzle so that the discharge speed of the detected nozzle can be within the reference discharge speed permissible range; and adjusting the discharge volume which comprises comparing the discharge volume of each nozzle with a predetermined reference discharge volume permissible range to detect a nozzle which has a discharge volume which deviates from the reference discharge volume permissible range; and adjusting at least one of a continuing time during which the applying voltage is held constant, an increasing time during which the applying voltage is increased, a decreasing time during which the applying voltage is decreased, and the magnitude of the applying voltage of the driving pulse so that the discharge volume of the detected nozzle can be within the reference discharge volume permissible range.

Adjusting the discharge volume may comprise adjusting at least one of the increasing time and the decreasing time if the discharge volume of the nozzle corresponds to a predetermined first discharge volume exceeding range which deviates from the reference discharge volume permissible range.

Adjusting the discharge volume may comprise adjusting at least one of the increasing time and the decreasing time after adjusting the continuing time if the discharge volume of the nozzle corresponds to a predetermined second discharge volume exceeding range which deviates from the first discharge volume exceeding range.

The reference discharge volume permissible range may be −3% to +3% with respect to a predetermined reference discharge volume, the first discharge volume exceeding range is one of +3% to +8% and −8% to −3% with respect to the reference discharge volume, and the second discharge volume exceeding range is one of more than +8% and less than −8% with respect to the reference discharge volume.

The reference discharge volume may be 25 pl to 30 pl.

The reference discharge speed permissible range may be −3% to +3% with respect to a predetermined reference discharge speed.

Adjusting the discharge volume may comprise minutely adjusting the magnitude of the applying voltage of the driving pulse by a unit of less than one fifth than a unit used to adjust the discharge speed.

The driving method of the inkjet apparatus comprise: applying the driving pulse which is adjusted by each nozzle to the plurality of piezoelectric elements after adjusting the discharge speed and adjusting the discharge volume; measuring the discharge speed and the discharge volume of the discharged object which may be discharged by the adjusted driving pulse through each nozzle; detecting a nozzle which may have at least one of the discharge speed and the discharge volume which deviates from the reference discharge speed permissible range and the reference discharge volume permissible range; and adjusting at least one of the discharge speed and the discharge volume of the detected nozzle by the adjusting the magnitude of the applying voltage so that the discharge speed of the detected nozzle can be within the reference discharge speed permissible range.

Adjusting the magnitude of the applying voltage may comprise adjusting the magnitude of the applying voltage by a unit of less than 0.1V.

Adjusting the discharge volume may comprise adjusting the continuing time, the increasing time, and the decreasing time by a unit of less 0.1 μs.

The driving pulse may comprise a single pulse.

The foregoing and/or other aspects of the subject matter disclosed herein can be achieved by providing an inkjet apparatus, comprising: a driving pulse applying unit which applies a driving pulse to a plurality of piezoelectric elements; a discharged object measuring unit which measures a discharge speed and a discharge volume of a discharged object which is discharged through a plurality of nozzles which respectively comprise the piezoelectric elements; a discharge speed control unit which compares the discharge speed of each nozzle with a predetermined reference discharge speed permissible range to detect a nozzle which has the discharge speed which deviates from the reference discharge speed permissible range, and adjusts the magnitude of an applying voltage of the driving pulse which is applied to the detected nozzle so that the discharge speed of the detected nozzle can be within the reference discharge speed permissible range; and a discharge volume control unit which compares the discharge volume of each nozzle with a predetermined reference discharge volume permissible range to detect the nozzle which has the discharge volume which deviates from the reference discharge volume permissible range, and adjusts at least one of a continuing time of an applying voltage of a driving pulse which is applied to the detected nozzle, the magnitude of the applying voltage of the driving pulse, an increasing time of the applying voltage of the driving pulse, and a decreasing time of the applying voltage of the driving pulse so that the discharge volume of the detected nozzle can be within the reference discharge volume permissible range.

The discharged object measuring unit may comprise an image taking unit which continuously takes an image of the discharged object which is discharged from the plurality of nozzles, and an image processing unit which calculates the volume and the speed of the discharged object based on the image from the image taking unit.

The discharge volume control unit may adjust at least one of the increasing time and the decreasing time if the discharge volume of the nozzle corresponds to a predetermined first discharge volume exceeding range which deviates from the reference discharge volume permissible range.

The discharge volume control unit may adjust at least one of the increasing time and the decreasing time after adjusting the continuing time if the discharge volume of the nozzle corresponds to a predetermined second discharge volume exceeding range which deviates out from the first discharge volume exceeding range.

The reference discharge volume permissible range may be −3% to +3% with respect to a predetermined reference discharge volume, the first discharge volume exceeding range is one of +3% to +8% and −8% to −3% with respect to the reference discharge volume, and the second discharge volume exceeding range is one of more than +8% and less than −8% with respect to the reference discharge volume.

The discharge volume control unit minutely may adjust the size of the applying voltage of the driving pulse by a smaller unit of less than one fifth than the discharge speed control unit.

The driving pulse applying unit applies the driving pulse which may be adjusted by each nozzle to the plurality of piezoelectric elements after the discharge speed control unit and the discharge volume control unit perform the adjustment, the discharged object measuring unit measures again the discharge speed and the discharge volume of the discharged object which may be discharged by the adjusted driving pulse through each nozzle, and if the nozzle which may have at least one of the discharge speed and the discharge volume which deviates from the reference discharge speed permissible range and the reference discharge volume permissible range is detected, at least one of the discharge speed and the discharge volume of the detected nozzle is adjusted by minutely adjusting the size of the applying voltage so that the discharge speed of the detected nozzle can be within the reference discharge speed permissible range.

The driving pulse may comprise a single pulse.

The foregoing and/or other aspects of the subject matter described herein can be achieved by providing a manufacturing method of a display apparatus, comprising: applying the same driving pulse to a plurality of piezoelectric elements; measuring a discharge speed and a discharge volume of a discharged object which is discharged by the applied driving pulse through a plurality of nozzles which respectively comprise the piezoelectric elements; adjusting the discharge speed which comprises comparing the discharge speed of each nozzle with a predetermined reference discharge speed permissible range to detect a nozzle which has the discharge speed which deviates from the reference discharge speed permissible range, and adjusting the magnitude of an applying voltage of the driving pulse which is applied to the detected nozzle so that the discharge speed of the detected nozzle can be within the reference discharge speed permissible range; adjusting the discharge volume which comprises comparing the discharge volume of each nozzle with a predetermined reference discharge volume permissible range to detect the nozzle which has the discharge volume which deviates from the reference discharge volume permissible range, and adjusting at least one of a continuing time of an applying voltage of a driving pulse which is applied to the detected nozzle, the magnitude of the applying voltage of the driving pulse, an increasing time of the applying voltage of the driving pulse, and a decreasing time of the applying voltage of the driving pulse so that the discharge volume of the detected nozzle can be within the reference discharge volume permissible range; and discharging the discharged object on a substrate after adjusting the discharge speed and the adjusting the discharge volume.

Adjusting the discharge volume may comprise adjusting at least one of the increasing time and the decreasing time if the discharge volume of the nozzle corresponds to a predetermined first discharge volume exceeding range which deviates from the reference discharge volume permissible range.

Adjusting the discharge volume may comprise adjusting at least one of the increasing time and the decreasing time after adjusting the continuing time if the discharge volume of the nozzle corresponds to a predetermined second discharge volume exceeding range which deviates from the first discharge volume exceeding range.

The reference discharge volume permissible range may be −3% to +3% with respect to a predetermined reference discharge volume, the first discharge volume exceeding range is one of +3% to +8% and −8% to −3% with respect to the reference discharge volume, and the second discharge volume exceeding range is one of more than +8% and less than −8% with respect to the reference discharge volume.

The manufacturing method of the display apparatus may comprise forming a plurality of discharged object accommodating grooves on the substrate before the discharging the discharged object.

The discharged object may be discharged on the substrate to form a color filter.

### BRIEF DESCRIPTION OF THE DRAWINGS

These and/or other aspects of the will become apparent and more readily appreciated from the following description of the exemplary embodiments, taken in conjunction with the accompanying drawings, in which:

FIG. 1 is a block diagram schematically illustrating an inkjet apparatus according to an exemplary embodiment;

FIG. 2 is a graph illustrating a driving pulse of the inkjet apparatus according to the exemplary embodiment;

FIG. 3 is a schematic view of a discharged object measuring unit of the inkjet apparatus according to the exemplary embodiment;

FIG. 4 illustrates a state taken by the discharged object measuring unit of the inkjet apparatus according to the exemplary embodiment;

FIG. 5A is a graph illustrating variation of a discharge speed and a discharge volume depending on a magnitude of an applying voltage of the driving pulse in the inkjet apparatus according to the exemplary embodiment;

FIGS. 5B to 5D are graphs illustrating variation of the discharge volume depending on an increasing time, a continuing time and a decreasing time of the applying voltage of the driving pulse in the inkjet apparatus according to the exemplary embodiment;

FIGS. 6A and 6B are control flowcharts of the inkjet apparatus according to the exemplary embodiment;

FIG. 7 is a sectional view of a liquid crystal display apparatus according to an exemplary embodiment;

FIG. 8 is an enlarged perspective view illustrating a discharged object accommodating groove in FIG. 7; and

FIGS. 9A to 9C are sectional views illustrating in sequence a manufacturing method of the liquid crystal display apparatus according to the exemplary embodiment.

### DETAILED DESCRIPTION OF EXEMPLARY EMBODIMENTS OF THE INVENTION

Reference will now be made in detail to the various embodiments, examples of which are illustrated in the accompanying drawings, wherein like reference numerals refer to like elements throughout. The exemplary embodiments are described below so as to explain the subject matter described herein by referring to the figures. An inkjet apparatus according to one embodiment is applied to a liquid crystal display apparatus. Alternatively, the inkjet apparatus may be applied to an organic light emitting diode (OLED) display apparatus, and other display apparatuses.

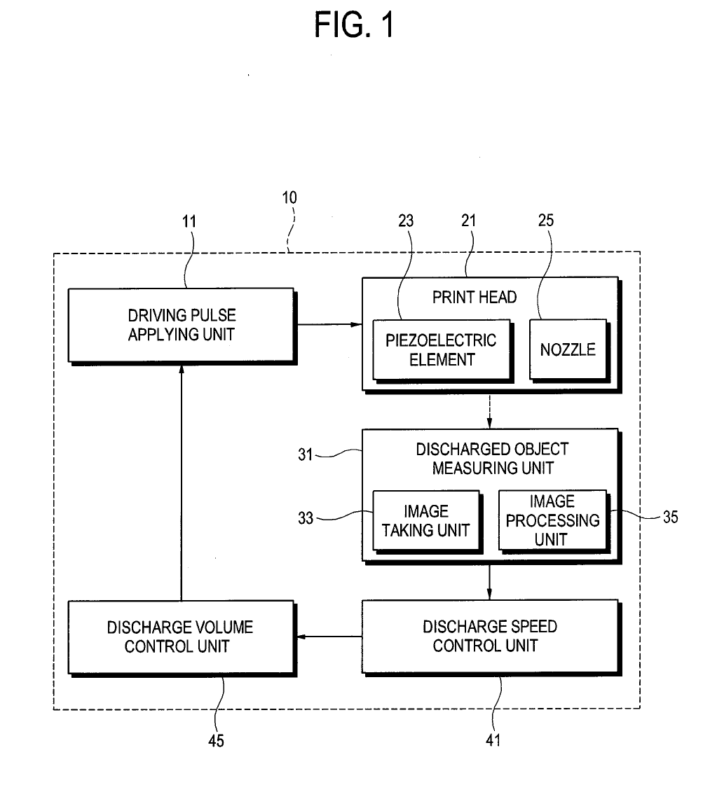

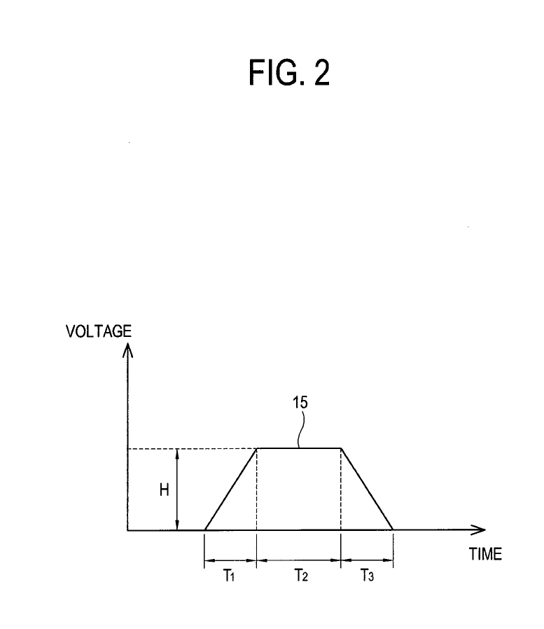

As shown in FIGS. 1 and 2, an inkjet apparatus 10 according to an exemplary embodiment includes a print head 21 including a plurality of nozzles 25 respectively provided with a piezoelectric element 23, a driving pulse applying unit 11 applying a driving pulse 15 to a plurality of piezoelectric elements 23, a discharged object measuring unit 31 measuring a discharge speed and a discharge amount of a discharged object 28 discharged through each nozzle 25 by means of the applied driving pulse 15, a discharge speed control unit 41 comparing the discharge speed of each nozzle 25 with a predetermined reference discharge speed permissible range to control an applying voltage of the driving pulse 15 so that each nozzle 25 can be within the reference discharge speed permissible range, and a discharge volume control unit 45 comparing the discharge volume of each nozzle 25 with a predetermined reference discharge volume permissible range to control the applying voltage of the driving pulse 15 so that each nozzle 25 can be within the reference discharge volume permissible range.

The driving pulse applying unit 11 applies the predetermined driving pulse 15 to the plurality of piezoelectric elements 23 to discharge the discharged object 28 such as an ink from the plurality of nozzles 25. At first, the driving pulse applying unit 11 applies the same driving pulse 15 to the piezoelectric element 23 corresponding to each nozzle 25 to measure the discharge speed and the discharge volume of the discharged object 28 discharged through each nozzle 25. Then, the driving pulse applying unit 11 receives a value adjusted by the discharge speed control unit 41 and the discharge volume control unit 45 based on a value measured by the discharged object measuring unit 31, and individually applies an adjusted driving pulse 15 to the piezoelectric element 23 corresponding to each nozzle 25. That is, the driving pulse applying unit 11 individually applies the driving pulse 15 individually adjusted depending on a condition of each nozzle 25 to each piezoelectric element 23.

The driving pulse 15 is applied to the piezoelectric element 23 corresponding to each nozzle 25 from the driving pulse applying unit 11. If the driving pulse 15 is applied to the piezoelectric element 23, the piezoelectric element 23 is transformed, and the discharged object 28 is discharged through the nozzle 25 due to the transformation of the piezoelectric element 23.

The driving pulse 15 may be adjusted by means of four factors that comprise adjusting either the magnitude “H” of the applying voltage, an increasing time T1 during which the applying voltage is increased, a continuing time T2 during which the applying voltage is held constant, and a decreasing time T3 during which the applying voltage is decreased. That is, the driving pulse 15 may be adjusted by using at least one of the four factors.

The magnitude “H” of the applying voltage is the maximum value of a voltage applied to the driving pulse 15. The magnitude “H” of the applying voltage according to the present exemplary embodiment is the same as a voltage applied during the continuing time T2.

The driving pulse 15 according to one embodiment employs a single pulse type. The single pulse type uses a single pulse for a single discharge, and the configuration of the driving pulse 15 is simple, thereby being easily controlled and having a reduced manufacturing cost. Also, the single pulse type may reduce fluid vibration in high speed printing, thereby improving print quality. Alternatively, the inkjet apparatus 10 may be applied to a double pulse type, and other various driving pulses.

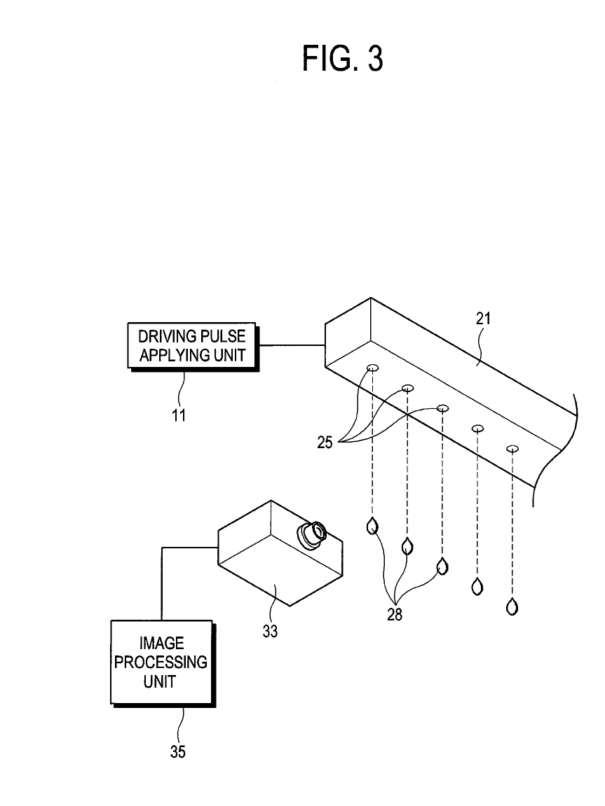

As shown in FIG. 3, the discharged object measuring unit 31 measures the discharge speed and the discharge volume of the discharged object 28 discharged through each nozzle 25 if the driving pulse 15 is applied to the plurality of piezoelectric elements 23 by means of the driving pulse applying unit 11. The discharged object measuring unit 31 includes an image taking unit 33 continuously taking images of the discharged object 28 discharged from the plurality of nozzles 25, and an image processing unit 35 calculating the volume and the speed of the discharged object 28 based on an image taken by the image taking unit 33.

The image taking unit 33 continuously takes images of the discharged object 28 discharged from each nozzle 25 with a predetermined interval of time. The image taking unit 33 according to one embodiment may take images at a rate of 30 frames per second. Alternatively, the image taking unit 33 may have various intervals of time. The image taking unit 33 moves in a lengthwise direction of the print head 21 to take images of the discharged object 28 discharged from each nozzle 25. Alternatively, the image taking unit 33 may be stationary, and the print head 21 may move.

The image processing unit 35 receives the taken image to calculate a falling distance “S” of the discharged object 28, and a radius “R” of the discharged object 28.

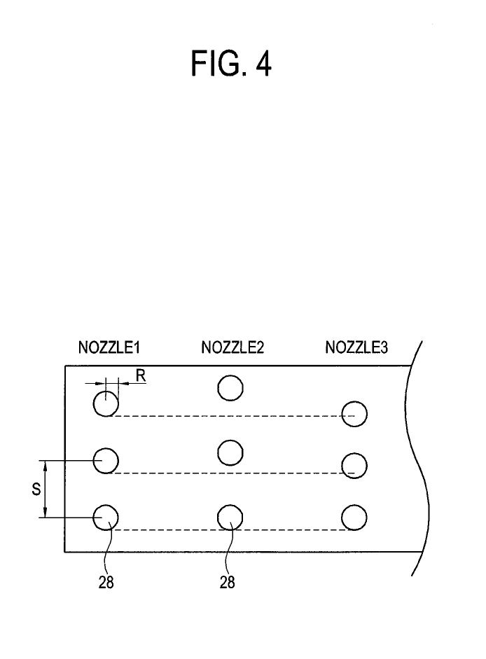

FIG. 4 illustrates the discharged objects 28 together with a falling position in a falling process of the discharged object 28 by each nozzle 28 with the same time interval. Here, the falling distance “S” is a distance between the discharged objects 28 positioned upward and downward. A time interval between the discharged objects 28 is the same as an image taking time interval of the image taking unit 33, and the time interval between the discharged objects 28 according to one embodiment is 1/30seconds.

The discharge speed of each nozzle 25 may be calculated by dividing the falling distance “S” between the discharged objects 28 by an image taking time interval. If the discharge speed of each nozzle 25 is different, the falling distance “S” of the discharged object 28 is different.

The discharge volume of each nozzle 25 is obtained by calculating the volume of the discharged object 28 appearing in the image. That is, the discharge volume may be calculated by using the radius “R” of the discharged object 28 appearing in the image, and a formula finding the volume of a sphere.

The discharged object measuring unit 31 according to one embodiment includes the image taking unit 33 and the image processing unit 35 to measure the discharge speed and the discharge volume of each nozzle 25. Alternatively, the discharged object measuring unit 31 may measure the discharge speed and the discharge volume of the discharged object by means of other known various methods.

The discharge speed control unit 41 compares the discharge speed of each nozzle 25 with the predetermined reference discharge speed permissible range to detect a nozzle 25 deviating from the reference discharge speed permissible range, and adjusts the magnitude “H” of the applying voltage of the driving pulse 15 applied to the detected nozzle 25 so that the detected nozzle 25 can be within the reference discharge speed permissible range.

The discharge speed control unit 41 according to one embodiment adjusts the magnitude “H” of the applying voltage of the driving pulse 15 before operating the discharge volume control unit 45. The discharge speed control unit 41 according to one embodiment adjusts the magnitude “H” of the applying voltage of the driving pulse 15 by a unit of more than five times the discharge volume control unit 45. That is, if the discharge volume control unit 45 adjusts the magnitude “H” of the applying voltage of the driving pulse 15 by a unit of 0.1V, the discharge speed control unit 41 adjusts the magnitude “H” of the applying voltage of the driving pulse 15 by a unit of more than 0.5V. Alternatively, the discharge speed control unit 41 may adjust the magnitude “H” of the applying voltage of the driving pulse 15 by various units such as more than three times the discharge volume control unit 45.

Since the discharge speed control unit 41 adjusts the magnitude “H” of the applying voltage of the driving pulse 15 by a larger unit than the discharge volume control unit 45, it is preferable but not necessary to adjust the discharge volume control unit 45 after adjusting the discharge speed control unit 41. Alternatively, the discharge speed control unit 41 and the discharge volume control unit 45 may be simultaneously adjusted, and the discharge volume control unit 45 may be adjusted before the discharge speed control unit 41.

The reference discharge speed permissible range according to one embodiment is −3% to +3% with respect to a predetermined reference discharge speed. However, the reference discharge speed permissible range may be variously determined to be −2% to +2%, −5% to +5%, etc. with respect to the reference discharge speed depending on a reference discharge volume, viscosity or a surface tension of the discharged object, etc. The predetermined reference discharge speed according to one embodiment is determined to be 2.5 m/s to 3.5 m/s. However, the reference discharge speed may be variously determined to be less than 2.5 m/s or more than 3.5 m/s depending on the reference discharge volume, the viscosity or the surface tension of the discharged object, etc.

The discharge volume control unit 45 compares the discharge volume of each nozzle 25 with the predetermined reference discharge volume permissible range to detect the nozzle 25 deviating from the reference discharge volume permissible range, and adjusts at least one of the continuing time T2 of the applying voltage of the driving pulse 15 applied to the detected nozzle 25, the increasing time T1 of the applying voltage of the driving pulse 15, the decreasing time T3 of the applying voltage of the driving pulse 15, and the magnitude “H” of the applying voltage of the driving pulse 15 so that the detected nozzle 25 can be within the reference discharge volume permissible range.

The discharge volume control unit 45 may control by means of various methods depending on the degree by which the discharge volume measured by the discharged object measuring unit 31 deviates from the reference discharge volume permissible range. A predetermined range by which the discharge volume measured by the discharged object measuring unit 31 deviates from the reference discharge volume permissible range refers to a first discharge volume exceeding range. A predetermined range by which the discharge volume measured by the discharged object measuring unit 31 deviates from the first discharge volume exceeding range refers to a second discharge volume exceeding range.

The reference discharge volume permissible range according to one embodiment is −3% to +3% with respect to the predetermined reference discharge volume. However, the reference discharge volume permissible range may be variously determined to be −2% to +2%, −5% to +5%, etc. with respect to the reference discharge volume depending on the reference discharge speed, the viscosity or the surface tension of the discharged object, etc. The predetermined reference discharge volume according to one embodiment is determined to be 2.5 pl (picoliter) to 3.0 pl. However, the reference discharge volume may be variously determined to be less than 2.5 pl or more than 3.0 pl depending on the reference discharge speed, the viscosity or the surface tension of the discharged object, etc.

If the reference discharge volume permissible range is −3% to +3% with respect to the reference discharge volume, the first discharge volume exceeding range according to one embodiment is one of +3% to +8%, −8% to −3% with respect to the reference discharge volume, and the second discharge volume exceeding range according to one embodiment is one of more than +8% and less than −8%. However, the first discharge volume exceeding range and the second discharge volume exceeding range may be variously determined depending on the reference discharge volume, the viscosity or the surface tension of the discharged object, etc.

If the discharge volume of the nozzle 25 corresponds to the first discharge volume exceeding range, the discharge volume control unit 45 adjusts at least one of the increasing time T1 and the decreasing time T3 of the applying voltage of the driving pulse 15. That is, if the discharge volume of the nozzle 25 corresponding to the first discharge volume exceeding range does not excessively deviate from the discharge volume permissible range, at least one of the increasing time T1 and the decreasing time T3 of the driving pulse 15 may be adjusted to minutely adjust the discharge volume.

If the discharge volume of the nozzle 25 corresponds to the second discharge volume exceeding range, the discharge volume control unit 45 may adjust the continuing time T2, and at least one of the increasing time T1 and the decreasing time T3 of the applying voltage of the driving pulse 15 in sequence. That is, if the discharge volume of the nozzle 25 corresponds to the second discharge volume exceeding range, at least one of the increasing time T1 and the decreasing time T3 of the driving pulse 15 may be adjusted to minutely adjust the discharge volume after adjusting the continuing time T2 of the driving pulse 15 to largely adjust the discharge volume. However, if the discharge volume of the nozzle 25 corresponds to the second discharge volume exceeding range, the discharge volume control unit 45 may adjust at least one of the continuing time T2, the increasing time T1 and the decreasing time T3 so that the discharge volume of the nozzle 25 can be within the reference discharge volume permissible range.

The discharge volume control unit 45 according to one embodiment adjusts the continuing time T2, the increasing time T1 and the decreasing time T3 of the driving pulse 15 by a unit of less than 0.1 μs. However, the continuing time T2, the increasing time T1 and the decreasing time T3 of the driving pulse 15 may be variously adjusted by units of 0.1 μs to 0.5 μs depending on the reference discharge volume, the viscosity or the surface tension of the discharged object, etc.

The discharge volume control unit 45 may adjust the magnitude of the applying voltage of the driving pulse 15 by a smaller unit than the discharge speed control unit 41. According to one embodiment, a minute adjusting process of the magnitude “H” of the applying voltage of the driving pulse 15 may be performed by a smaller unit of less than one fifth than the discharge speed control unit 41. According to one embodiment, if the discharge speed control unit 41 adjusts the magnitude “H” of the applying voltage of the driving pulse 15 by a unit of 0.5V, the discharge volume control unit 45 minutely adjusts the magnitude “H” of the applying voltage of the driving pulse 15 by a unit of less than 0.1V. However, the discharge volume control unit 45 may variously adjust the magnitude “H” of the applying voltage of the driving pulse 15 by units of 0.1V to 0.5V, etc. depending on the reference discharge volume, the viscosity or the surface tension of the discharged object, etc.

The minute adjusting process of the magnitude “H” of the applying voltage of the driving pulse 15 may be employed to more minutely adjust the discharge volume than the adjustment of the increasing time T1, the continuing time T2 and the decreasing time T3. Also, the minute adjusting process of the magnitude “H” of the applying voltage of the driving pulse 15 may be employed to correct again the discharge speed and the discharge volume after the adjustment of the discharge volume is completed.

A correcting process of the discharge speed and the discharge volume is as follows. At first, after adjusting the discharge speed control unit 41 and the discharge volume control unit 45, the driving pulse applying unit 11 applies the driving pulse 15 adjusted by each nozzle 25 to the plurality of piezoelectric elements 23. Then, the discharged object measuring unit 31 measures again the discharge speed and the discharge volume of the discharged object 28 discharged through each nozzle 25 by means of the adjusted driving pulse 15. Then, if the discharge speed control unit 41 and the discharge volume control unit 45 detect the nozzle 25 of which the discharge speed and the discharge volume deviate from at least one of the reference discharge speed permissible range and the reference discharge volume permissible range, the minute adjusting process of the magnitude “H” of the applying voltage may be employed so that the detected nozzle 25 can be within the reference discharge speed permissible range.

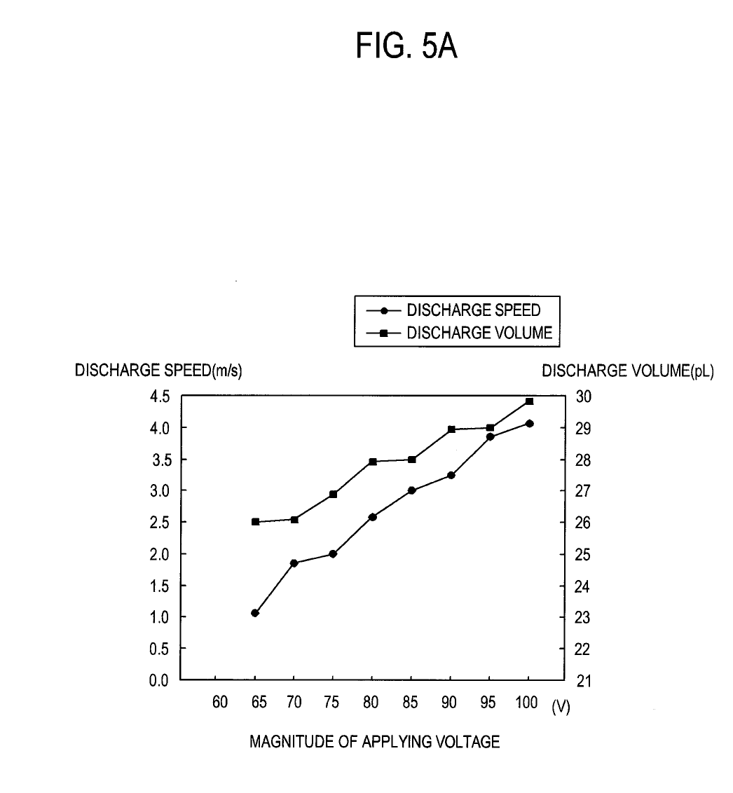

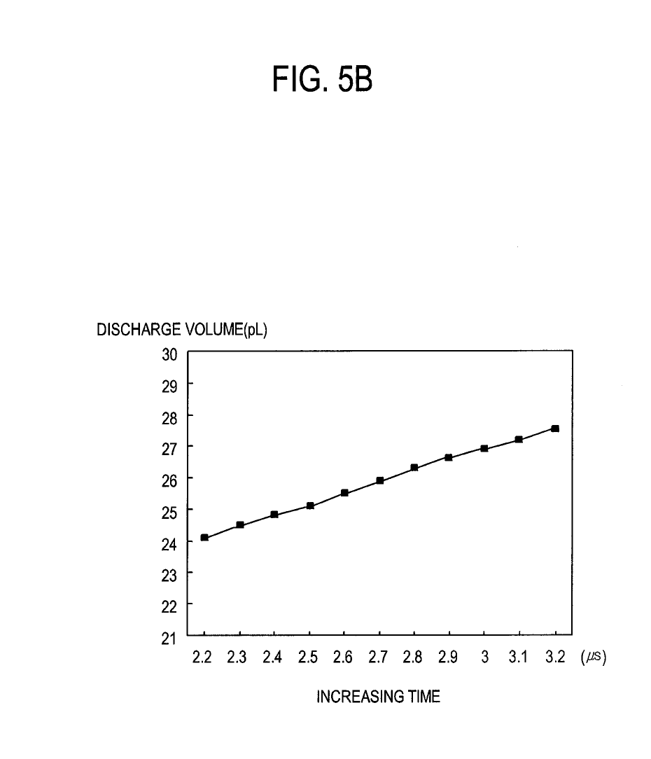

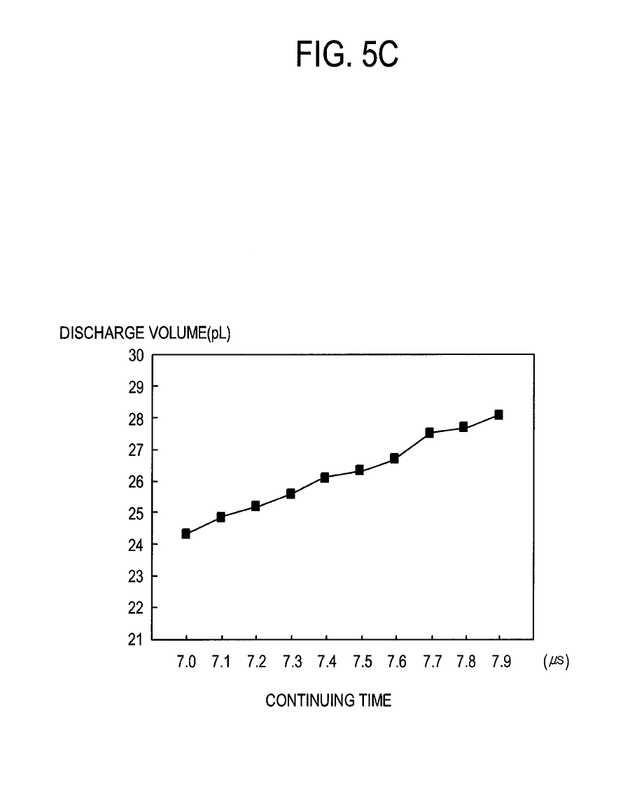

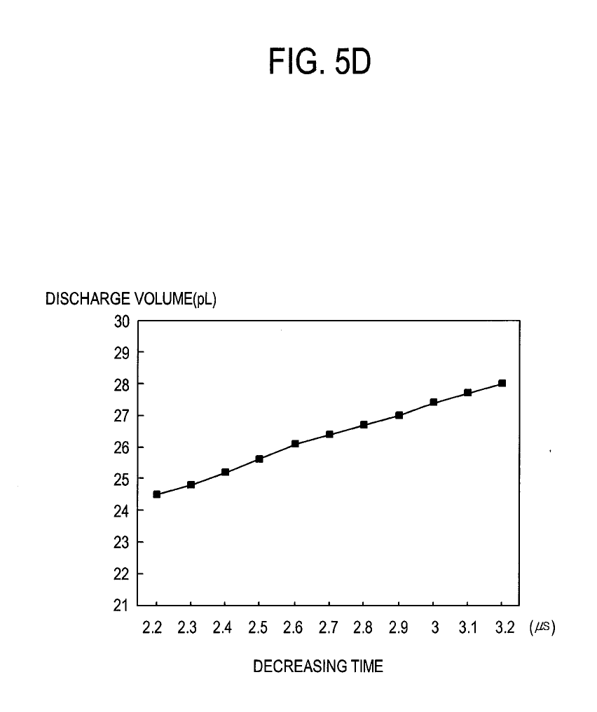

FIGS. 5A to 5D are graphs illustrating variation of the discharge speed and the discharge volume depending on variation of the magnitude “H”, the increasing time T1, the continuing time T2 and the decreasing time T3 of the applying voltage of the driving pulse in the inkjet apparatus according to one embodiment.

These graphs illustrate an experimental value under the condition that the reference discharge speed is approximately 3.0 m/s, the reference discharge volume is approximately 28 pl, the viscosity of the discharged object 28 is approximately 12 cps, and the surface tension of the discharged object 28 is approximately 28 dyne/cm. Here, the magnitude “H” of the applying voltage of an initial driving pulse 15 approximately 80V, the continuing time T2 is approximately 7.5 μs, and the increasing time T1 and the decreasing time T3 are respectively approximately 2.5 Ξs.

As shown in FIG. 5A, when the magnitude “H” of the applying voltage of the driving pulse 15 varies by a unit of 0.5V, the discharge speed varies by approximately 0.06 m/s. Also, when the magnitude “H” of the applying voltage of the driving pulse 15 varies by a unit of 0.1V, the discharge volume varies by approximately 0.03 pl.

As shown in FIGS. 5B to 5D, when the increasing time T1 of the applying voltage of the driving pulse 15 varies by a unit of 0.1 μs, the discharge volume varies by approximately 0.3 pl. When the continuing time T2 of the applying voltage of the driving pulse 15 varies by a unit of 0.1 μs, the discharge volume varies by approximately 0.5 pl. When the decreasing time T3 of the applying voltage of the driving pulse 15 varies by a unit of 0.1 μs, the discharge volume varies by approximately 0.3 pl.

Although not shown, the variation of the discharge speed is smaller when the increasing time T1, the continuing time T2 and the decreasing time T3 of the applying voltage of the driving pulse 15 vary by a unit of 0.1 μs when the magnitude “H” of the applying voltage of the driving pulse 15 varies by a unit of 0.5V.

Accordingly, in controlling the discharge speed control unit 41, the discharge speed can be easily adjusted to be within the reference discharge speed permissible range by adjusting the size “H” of the applying voltage of the driving pulse 15 by a unit of 0.5V. Also, in controlling the discharge volume control unit 45, if the discharge volume belongs to the first discharge volume exceeding range, the discharge speed can be easily adjusted to be within the reference discharge volume permissible range by adjusting at least one of the increasing time T1 and the decreasing time T3 which are capable of being adjusted more minutely than the continuing time T2 by a unit of 0.1 μs. Also, if the discharge volume belongs to the second discharge volume exceeding range, the discharge speed can be easily adjusted to be within the reference discharge volume permissible range by adjusting at least one of the increasing time T1 and the decreasing time T3 by a unit of 0.1 μs after adjusting the continuing time T2. Also, in the minute adjusting process of the magnitude “H” of the applying voltage of the driving pulse 15, the discharge volume and the discharge speed can be minutely adjusted by varying the magnitude H of the applying voltage by a unit of 0.1V.

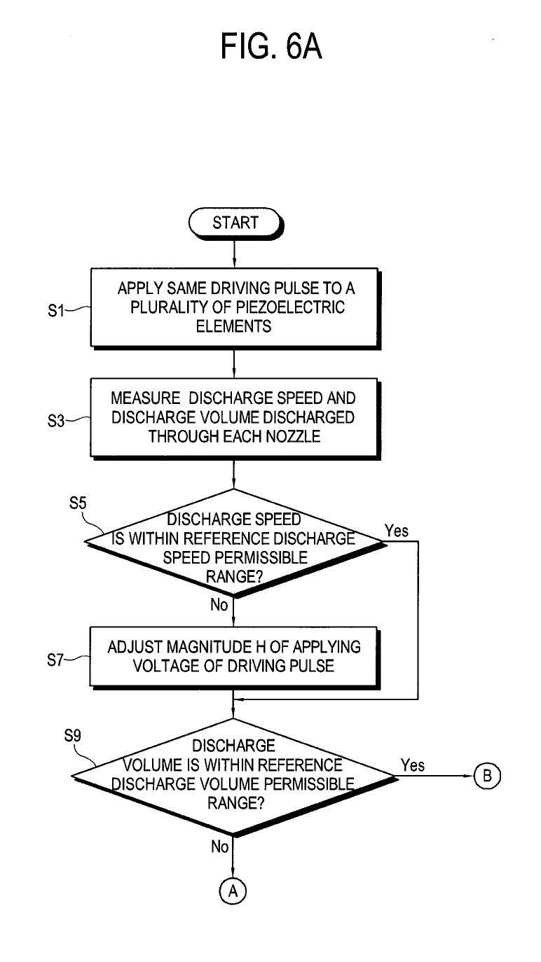

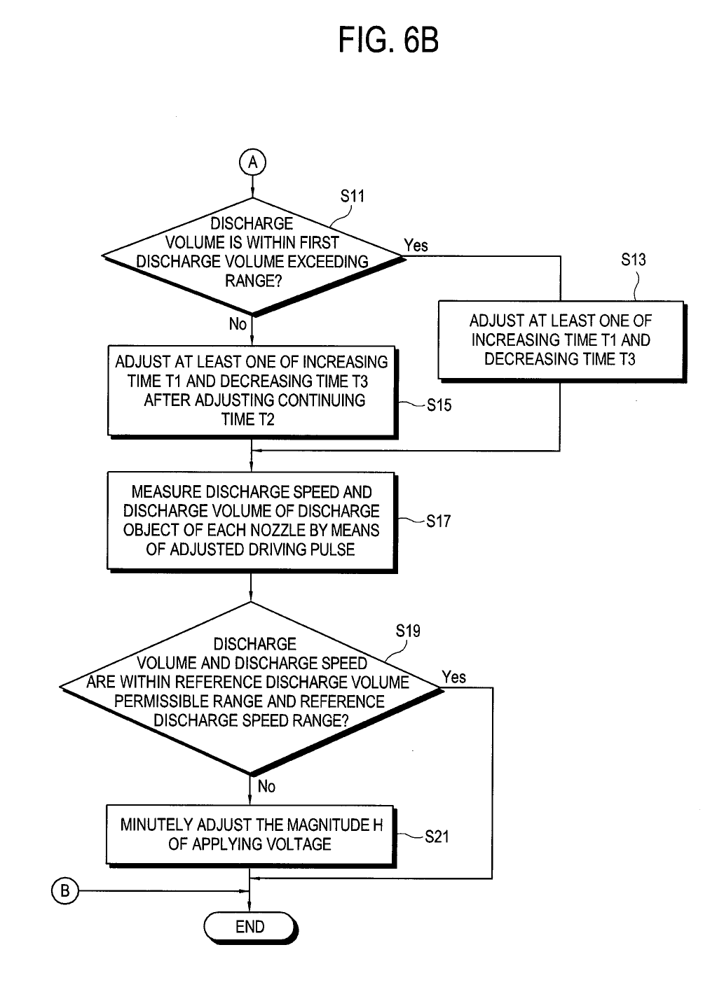

FIGS. 6A and 6B are control flowcharts of the inkjet apparatus according to one embodiment. Hereinafter, a driving method of the inkjet apparatus will be described in detail by referring to FIGS. 6A and 6B.

At first, the same driving pulse 15 is applied to the plurality of piezoelectric elements 23 (S1). Then, the discharge speed and the discharge volume of the discharged object 28 discharged through each nozzle 25 are measured by using the discharged object measuring unit 31 (S3). Then, in a discharged speed adjusting operation, the discharge speed of each nozzle 25 is compared with the reference discharge speed permissible range (S5). For the nozzle 25 having the discharge speed belonging to the reference discharge speed permissible range, a discharge volume adjusting operation is performed without adjusting the discharge speed thereof. However, for the nozzle 25 having the discharge speed deviating from the reference discharge speed permissible range, the magnitude “H” of the applying voltage of the driving pulse 15 is adjusted to adjust the discharge speed thereof (S7). Here, the magnitude “H” of the applying voltage may be adjusted by an appropriate unit to efficiently adjust the discharge speed. In the discharge speed adjusting operation according to one embodiment, the magnitude “H” of the applying voltage may be adjusted by a unit of more than 0.5V. After the discharge speed adjusting operation, the discharge volume of the each nozzle 25 is compared with the reference discharge volume permissible range in the discharge volume adjusting operation (S9). For the nozzle 25 having the discharge volume belonging to the reference discharge volume permissible range, the applying voltage adjustment of the driving pulse 15 is ended. However, for the nozzle 25 having the discharge volume deviating from the reference discharge volume permissible range, at least one of the increasing time T1, the continuing time T2 and the decreasing time T3 of the applying voltage of the driving pulse 15 is adjusted to adjust the discharge volume thereof. In more detail, for the nozzle 25 having the discharge volume belonging to the first discharge volume exceeding range, at least one of the increasing time T1 and the decreasing time T3 of the applying voltage of the driving pulse 15 is adjusted to adjust the discharge volume thereof (S13). Also, for the nozzle 25 having the discharge volume deviating from the first discharge volume exceeding range, that is, belonging to the second discharge volume exceeding range, the continuing time T2, and at least one of the increasing time T1 and the decreasing time T3 of the applying voltage of the driving pulse 15 are adjusted in sequence to adjust the discharge volume thereof (S15). Then, the discharge volume and the discharge speed of each nozzle 25 according to the adjusted driving pulse 15 are measured again (S17). Then, the discharge volume and the discharge speed of each nozzle 25 are compared with the reference discharge volume permissible range and the reference discharge speed permissible range (S19). Then, for the nozzle 25 having the discharge volume and the discharge speed belonging to the reference discharge volume permissible range and the reference discharge speed permissible range, the applying voltage adjustment of the driving pulse 15 is ended. However, for the nozzle 25 having at least one of the discharge volume and the discharge speed deviating from the reference discharge volume permissible range and the reference discharge speed permissible range, the magnitude “H” of the applying voltage of the driving pulse 15 is minutely adjusted by means of the minute adjusting process (S21). Here, the minute adjusting process according one embodiment adjusts the magnitude “H” of the applying voltage by a unit of less than one fifth in comparison with an adjusting unit by which the discharge speed adjusting operation adjusts the magnitude “H” of the applying voltage. That is, if the discharge speed adjusting operating adjusts the magnitude “H” of the applying voltage by a unit of 0.5V, the minute adjusting process may adjust the magnitude “H” of the applying voltage by a unit of less than 0.1V.

After the adjustment of the discharge speed and the discharge volume as described above is completed, the adjusted driving pulse 15 is individually applied to each nozzle 25.

Accordingly, the inkjet apparatus 10 according to one embodiment can individually control the plurality of nozzles 25, simply and conveniently to control the discharge volume and the discharge speed of each nozzle 25, and reduce a manufacturing cost of a driving controller by the simple driving method.

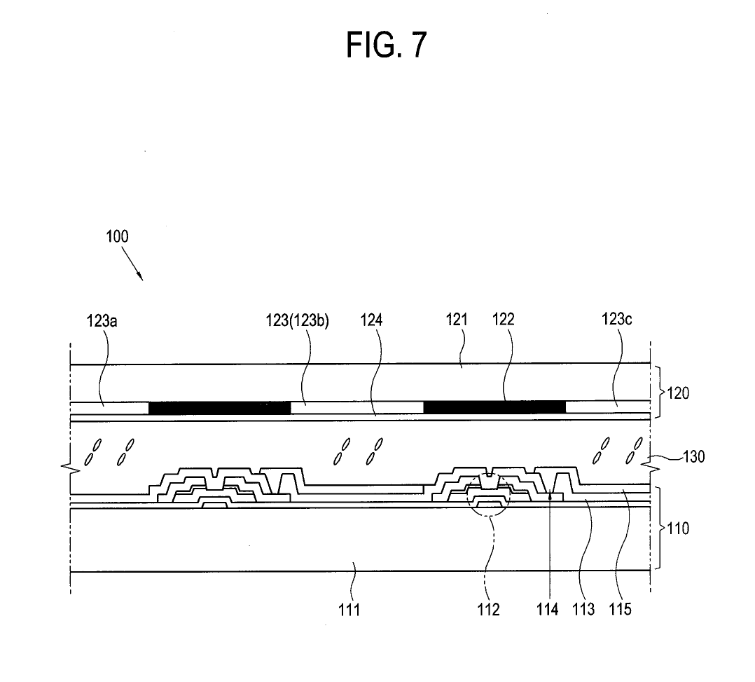

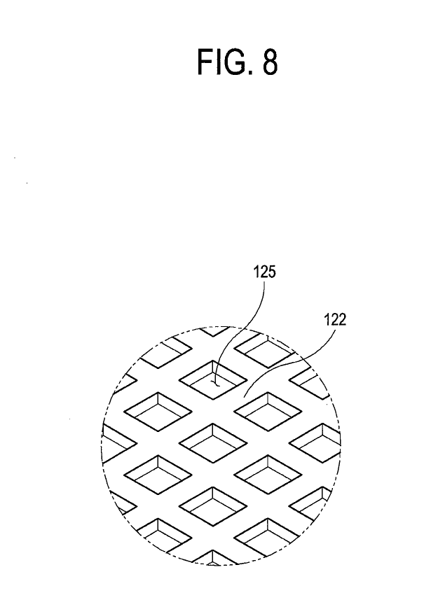

Hereinafter, a liquid crystal display apparatus 100 according to one embodiment will be described by referring to FIGS. 7 and 8. FIG. 7 is a sectional view of the liquid crystal display apparatus 100, and FIG. 8 illustrates a discharged object accommodating groove 125 of the liquid crystal display apparatus 100.

The liquid crystal display apparatus 100 according to one embodiment includes a thin film transistor substrate 110, a color filter substrate 120, and a liquid crystal layer 130 positioned between both substrates 110 and 120.

The thin film transistor substrate 110 includes an insulating substrate 111, and a plurality of thin film transistors 112 formed on the insulating substrate 111. The thin film transistor 112 is covered by a passivation layer 113, and a part of the passivation layer 113 is removed to form a contact hole 114 exposing the thin film transistor 112. A pixel electrode 115 formed of a transparent conductive material is connected with the thin film transistor 112 through the contact hole 114.

The color filter substrate 120 includes an insulating substrate 121, and a plurality of discharged object accommodating grooves 125 formed on the insulating substrate 121. The discharged object accommodating groove 125 is a space for forming a color filter 123, and is formed by means of a black matrix 122. Alternatively, the discharged object accommodating groove 125 may be formed of various known materials.

The black matrix 122 is formed on the insulating substrate 121 in a matrix shape. The black matrix 122 may be formed of a photoresist material including a black pigment, and is formed to correspond to the thin film transistor 112 and a wiring (not shown) of the thin film transistor substrate 110.

The discharged object accommodating groove 122 is filled with the color filter 123. The color filter 123 includes three sub layers 123a, 123b, and 123c formed of an organic material, and having different colors one after another. A common electrode 124 formed of a transparent conductive material is formed over the black matrix 122 and the color filter 123.

An arrangement of the liquid crystal layer 130 positioned between both substrates 110 and 120 is determined by means of an electric field which the pixel electrode 115 and the common electrode 124 form. Transmission of a light supplied from a lower part of the thin film transistor substrate 110 is adjusted through the liquid crystal layer 130, and the light is endowed with a color in passing through the color filter 123.

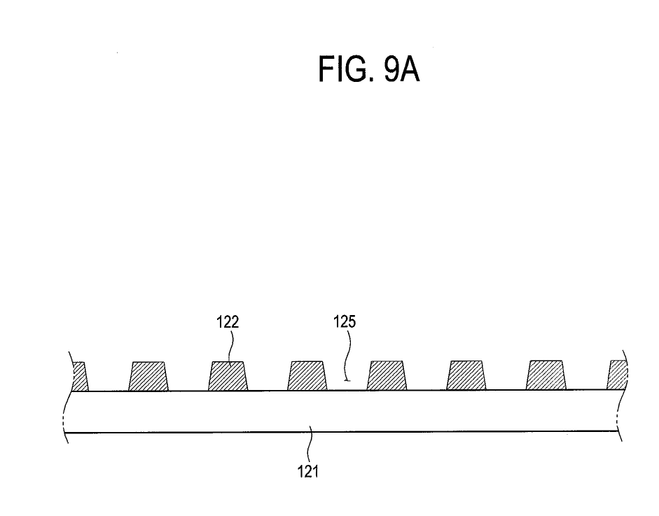

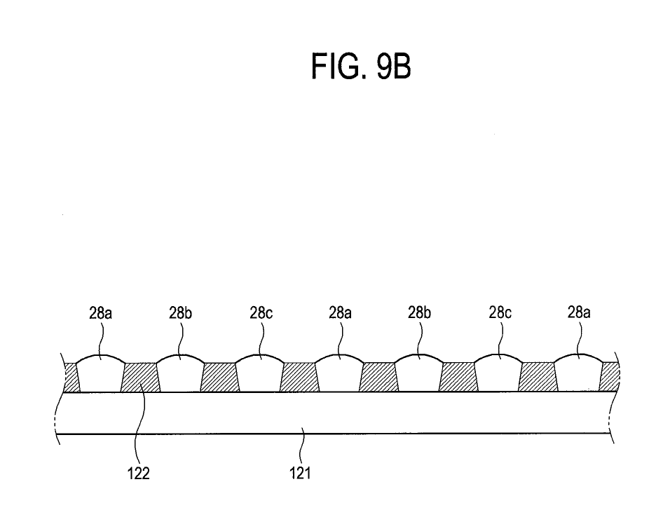

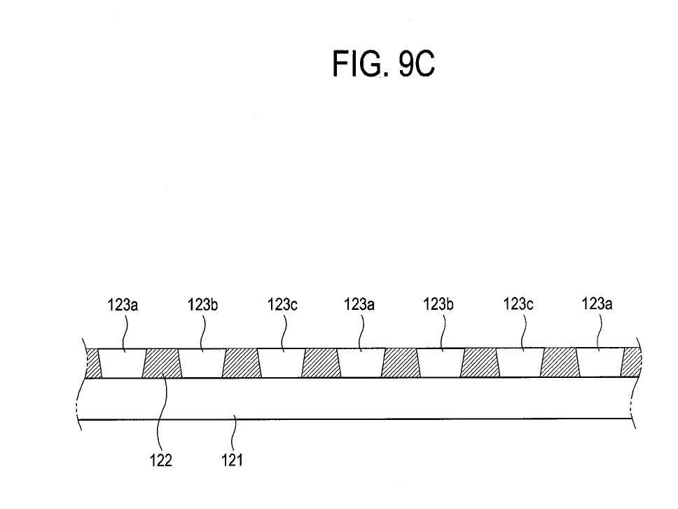

FIGS. 9A to 9C are sectional views illustrating in sequence a manufacturing method of the liquid crystal display apparatus according to one embodiment, and illustrate manufacturing of the color filter 123.

As shown in FIG. 9A, the black matrix 122 having a matrix shape is formed to form the discharged object accommodating groove 125 on the insulating substrate 121. The black matrix 122 is formed by exposing and developing a photoresist layer.

As shown in FIG. 9B, color filter inks 28a, 28b and 28c, that is, the discharged object 28 is discharged to each discharged object accommodating groove 125 through each nozzle 25 under the state that the discharge volume and the discharge speed of each nozzle 25 are adjusted by means of the inkjet apparatus 10. Here, the color filter inks 28a, 28b and 28c are discharged to have the substantially same volume through each nozzle 25 to have a uniform thickness in the discharged object accommodating groove 125.

FIG. 9c illustrates the color filter 123 formed by drying the color filter inks 28a, 28b and 28c. Then, if the common electrode 124 is formed on the black matrix 122 and the color filter 123, the color filter substrate 120 is completely manufactured. The color filter 123 of the completely manufactured color filter substrate 120 has a uniform height, thereby reducing deterioration of contrast ratio and a stain generation.

In FIGS. 7 to 9C, the inkjet apparatus according to one embodiment is applied to the manufacturing process of the color filter substrate of the liquid crystal display apparatus. Alternatively, the inkjet apparatus may be applied to an organic semiconductor layer manufacturing process of a display apparatus, a manufacturing process of an organic layer including a light emitting layer of an organic light emitting diode (OLED) display apparatus, and other display apparatuses.

As described above, various embodiments provide an inkjet apparatus individually controlling a plurality of nozzles to simply and easily control a discharge volume and a discharge speed of each nozzle, and to reduce the manufacturing cost of a driving controller.

Also provided is a driving method of an inkjet apparatus individually controlling a plurality of nozzles provided to the inkjet apparatus to simply and easily control a discharge volume and a discharge speed of each nozzle, and to reduce the manufacturing cost of a driving controller.

Also, one embodiment provides a manufacturing method of a display apparatus using an inkjet apparatus individually controlling a plurality of nozzles to simply and easily control a discharge volume and a discharge speed of each nozzle, and to reduce the manufacturing cost of a driving controller.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A driving method of an inkjet apparatus, comprising:
applying the same driving pulse to a plurality of piezoelectric elements;
measuring a discharge speed and a discharge volume of a discharged object which is discharged by the applied driving pulse through a plurality of nozzles which respectively comprise the piezoelectric elements;
adjusting the discharge speed which comprises comparing the discharge speed of each nozzle with a predetermined reference discharge speed permissible range to detect a nozzle which has a discharge speed which deviates from the reference discharge speed permissible range, and adjusting the magnitude of an applying voltage of the driving pulse which is applied to the detected nozzle so that the discharge speed of the detected nozzle can be within the reference discharge speed permissible range; and
adjusting the discharge volume which comprises comparing the discharge volume of each nozzle with a predetermined reference discharge volume permissible range to detect a nozzle which has a discharge volume which deviates from the reference discharge volume permissible range, and adjusting at least one of a continuing time of an applying voltage of a driving pulse which is applied to the detected nozzle, an increasing time of the applying voltage of the driving pulse, a decreasing time of the applying voltage of the driving pulse, and the magnitude of the applying voltage of the driving pulse so that the discharge volume of the detected nozzle can be within the reference discharge volume permissible range.

2. The driving method of the inkjet apparatus according to claim 1, wherein the adjusting the discharge volume comprises adjusting at least one of the increasing time and the decreasing time if the discharge volume of the nozzle corresponds to a predetermined first discharge volume exceeding range which deviates from the reference discharge volume permissible range.

3. The driving method of the inkjet apparatus according to claim 2, wherein the adjusting the discharge volume comprises adjusting at least one of the increasing time and the decreasing time after adjusting the continuing time if the discharge volume of the nozzle corresponds to a predetermined second discharge volume exceeding range which deviates out from the first discharge volume exceeding range.

4. The driving method of the inkjet apparatus according to claim 3, wherein the reference discharge volume permissible range is −3% to +3% with respect to a predetermined reference discharge volume, the first discharge volume exceeding range is one of +3% to +8% and −8% to −3% with respect to the reference discharge volume, and the second discharge volume exceeding range is one of more than +8% and less than −8% with respect to the reference discharge volume.

5. The driving method of the inkjet apparatus according to claim 4, wherein the reference discharge volume is 25 pl to 30 pl.

6. The driving method of the inkjet apparatus according to claim 1, wherein the reference discharge speed permissible range is −3% to +3% with respect to a predetermined reference discharge speed.

7. The driving method of the inkjet apparatus according to claim 1, wherein the adjusting the discharge volume comprises minutely adjusting the magnitude of the applying voltage of the driving pulse by a smaller unit of less than one fifth than the adjusting the discharge speed.

8. The driving method of the inkjet apparatus according to claim 7, further comprising:
applying the driving pulse which is adjusted by each nozzle to the plurality of piezoelectric elements after the adjusting the discharge speed and the adjusting the discharge volume,
measuring the discharge speed and the discharge volume of the discharged object which is discharged by the adjusted driving pulse through each nozzle, and
detecting the nozzle which has at least one of the discharge speed and the discharge volume which deviates from the reference discharge speed permissible range and the reference discharge volume permissible range, and adjusting at least one of the discharge speed and the discharge volume of the detected nozzle by the minutely adjusting the magnitude of the applying voltage so that the discharge speed of the detected nozzle can be within the reference discharge speed permissible range.

9. The driving method of the inkjet apparatus according to claim 8, wherein the minutely adjusting the magnitude of the applying voltage comprises adjusting the magnitude of the applying voltage by a unit of less than 0.1V.

10. The driving method of the inkjet apparatus according to claim 1, wherein the adjusting the discharge volume comprises adjusting the continuing time, the increasing time and the decreasing time by a unit of less 0.1 μs.

11. The driving method of the inkjet apparatus according to claim 1, wherein the driving pulse comprises a single pulse.

12. An inkjet apparatus, comprising:
a driving pulse applying unit which applies a driving pulse to a plurality of piezoelectric elements;
a discharged object measuring unit which measures a discharge speed and a discharge volume of a discharged object which is discharged through a plurality of nozzles which respectively comprise the piezoelectric elements if the driving pulse applying unit applies the same driving pulse to the plurality of piezoelectric elements;
a discharge speed control unit which compares the discharge speed of each nozzle with a predetermined reference discharge speed permissible range to detect the nozzle which has the discharge speed which deviates from the reference discharge speed permissible range, and adjusts the magnitude of an applying voltage of the driving pulse which is applied to the detected nozzle so that the discharge speed of the detected nozzle can be within the reference discharge speed permissible range; and
a discharge volume control unit which compares the discharge volume of each nozzle with a predetermined reference discharge volume permissible range to detect the nozzle which has the discharge volume which deviates from the reference discharge volume permissible range, and adjusts at least one of a continuing time of an applying voltage of a driving pulse which is applied to the detected nozzle, the magnitude of the applying voltage of the driving pulse, an increasing time of the applying voltage of the driving pulse, and a decreasing time of the applying voltage of the driving pulse so that the discharge volume of the detected nozzle can be within the reference discharge volume permissible range.

13. The inkjet apparatus according to claim 12, wherein the discharged object measuring unit comprises an image taking unit which continuously takes an image of the discharged object which is discharged from the plurality of nozzles, and an image processing unit which calculates the volume and the speed of the discharged object based on the image from the image taking unit.

14. The inkjet apparatus according to claim 12, wherein the discharge volume control unit adjusts at least one of the increasing time and the decreasing time if the discharge volume of the nozzle corresponds to a predetermined first discharge volume exceeding range which deviates from the reference discharge volume permissible range.

15. The inkjet apparatus according to claim 14, wherein the discharge volume control unit adjusts at least one of the increasing time and the decreasing time after adjusting the continuing time if the discharge volume of the nozzle corresponds to a predetermined second discharge volume exceeding range which deviates out from the first discharge volume exceeding range.

16. The inkjet apparatus according to claim 15, wherein the reference discharge volume permissible range is −3% to +3% with respect to a predetermined reference discharge volume, the first discharge volume exceeding range is one of +3% to +8% and −8% to −3% with respect to the reference discharge volume, and the second discharge volume exceeding range is one of more than +8% and less than −8% with respect to the reference discharge volume.

17. The inkjet apparatus according to claim 12, wherein the discharge volume control unit minutely adjusts the size of the applying voltage of the driving pulse by a smaller unit of less than one fifth than the discharge speed control unit.

18. The inkjet apparatus according to claim 17, wherein the driving pulse applying unit applies the driving pulse which is adjusted by each nozzle to the plurality of piezoelectric elements after the discharge speed control unit and the discharge volume control unit perform the adjustment,
the discharged object measuring unit measures again the discharge speed and the discharge volume of the discharged object which is discharged by the adjusted driving pulse through each nozzle, and
if the nozzle which has at least one of the discharge speed and the discharge volume which deviates from the reference discharge speed permissible range and the reference discharge volume permissible range is detected, at least one of the discharge speed and the discharge volume of the detected nozzle is adjusted by the minutely adjusting the size of the applying voltage so that the discharge speed of the detected nozzle can be within the reference discharge speed permissible range.

19. The inkjet apparatus according to claim 12, wherein the driving pulse comprises a single pulse.

20. A manufacturing method of a display apparatus, comprising:
applying the same driving pulse to a plurality of piezoelectric elements;
measuring a discharge speed and a discharge volume of a discharged object which is discharged by the applied driving pulse through a plurality of nozzles which respectively comprise the piezoelectric elements;
adjusting the discharge speed which comprises comparing the discharge speed of each nozzle with a predetermined reference discharge speed permissible range to detect the nozzle which has the discharge speed which deviates from the reference discharge speed permissible range, and adjusting the magnitude of an applying voltage of the driving pulse which is applied to the detected nozzle so that the discharge speed of the detected nozzle can be within the reference discharge speed permissible range;
adjusting the discharge volume which comprises comparing the discharge volume of each nozzle with a predetermined reference discharge volume permissible range to detect the nozzle which has the discharge volume which deviates from the reference discharge volume permissible range, and adjusting at least one of a continuing time of an applying voltage of a driving pulse which is applied to the detected nozzle, the magnitude of the applying voltage of the driving pulse, an increasing time of the applying voltage of the driving pulse, and a decreasing time of the applying voltage of the driving pulse so that the discharge volume of the detected nozzle can be within the reference discharge volume permissible range; and
discharging the discharged object on a substrate after the adjusting the discharge speed and the adjusting the discharge volume.

21. The manufacturing method of the display apparatus according to claim 20, wherein the adjusting the discharge volume comprises adjusting at least one of the increasing time and the decreasing time if the discharge volume of the nozzle corresponds to a predetermined first discharge volume exceeding range which deviates from the reference discharge volume permissible range.

22. The manufacturing method of the display apparatus according to claim 21, wherein the adjusting the discharge volume comprises adjusting at least one of the increasing time and the decreasing time after adjusting the continuing time if the discharge volume of the nozzle corresponds to a predetermined second discharge volume exceeding range which deviates out from the first discharge volume exceeding range.

23. The manufacturing method of the display apparatus according to claim 22, wherein the reference discharge volume permissible range is −3% to +3% with respect to a predetermined reference discharge volume, the first discharge volume exceeding range is one of +3% to +8% and −8% to −3% with respect to the reference discharge volume, and the second discharge volume exceeding range is one of more than +8% and less than −8% with respect to the reference discharge volume.

24. The manufacturing method of the display apparatus according to claim 20, further comprising forming a plurality of discharged object accommodating grooves on the substrate before the discharging the discharged object.

25. The manufacturing method of the display apparatus according to claim 20, wherein the discharged object is discharged on the substrate to form a color filter.
